(19) United States
(12) Patent Application Publication
(10) Pub. No.: US 2004/0168115 A1
(43) Pub. Date: Aug. 26, 2004

(54) Method and system for visualizing data from multiple, cached data sources with user defined treemap reports

(76) Inventors: Bill G. Bauernschmidt, Arvada, CO (US); Jonathan L. Schuck, Frederick, CO (US); Natalie J. Webb, Parker, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 10/371,638

(22) Filed: Feb. 21, 2003

(51) Int. Cl. G06F 17/00

(52) U.S. Cl. 715/500

(57) ABSTRACT

A method for displaying a user-configurable data report such as a treemap. The method includes creating a first data report by processing a set of report data that has been configured to a standardized format, e.g., an XML document. A user interface is provided on the monitor and the first data report is displayed in a report area or window of the user interface. The method includes displaying a hierarchical control tree for the first data report in a control area of the user interface. A selection of one of the nodes of the control tree is received via the user interface and the method includes responding by creating a second data report based on the node selection. The second data report is displayed in the report area. The method includes receiving user input of report creation parameters that are then used in creating the second data report.

### BACKGROUND OF THE INVENTION

1. Field of the Invention

The present invention relates, in general, to methods and systems for organizing and displaying data to users, and, more particularly, to software, systems, and methods for displaying large sets of related data in a user-friendly manner that includes preprocessing data from multiple data sources, creating treemap reports for display on a client monitor based on the preprocessed data, and generating at run time additional treemap reports based on user input.

2. Relevant Background.

In recent years, the volume and type of information available for making decisions has continued to rapidly expand. For example, computer and digital data systems allow business managers to track nearly every function of their business and in every geographic location. The manager can require that every assembly facility track the suppliers of parts and components that are purchased, track which assembly line, and even which individual, assembled products, and then track which products failed and what caused the product failure. The manager can then use this information in making purchasing, manufacturing, and distributing decisions. Likewise, the availability of information has the potential to transform many other activities by allowing decision makers, such as industrial managers, government entities, school districts, and nearly every other person and entity faced with a complex decision, to make more accurate decisions by basing such decisions on accurate, easy-to-understand data.

Unfortunately, the amount of data or information that is available is often extremely large and difficult to present in a clear manner that a decision maker can quickly utilize. As a result, the large volume of collected and available data is wasted or simply overwhelms the decision maker. In the manufacturing example, a company may be producing hundreds of products at one time in numerous geographically disperse facilities using a large quantity of suppliers. Computer systems allow the data to be collected more easily but have not yet been fully utilized to present the data in a manner that is more readily digested and understood. Reports are often simply prepared using word processing, spreadsheet, and database software or a combination of these software applications. For example, large reports with the information provided in text or tables are provided in electronic versions that can be transferred, such as in e-mail messages, to decision makers for viewing on their computer monitors. Pie charts and graphs may also be provided, but the information is typically static and two-dimensional and closely resembles the hard copy version of reports that have been available for many years. The report generator typically has to guess what facts and data are important to the decision maker and provide that information in a form that they believe will be useful and desirable but that may not suit the needs of the user. The decision maker generally cannot readily use their monitor or user interface to change the form of the report or to submit queries to gather more information based on the information presented in the report.

One interesting approach to presenting large volumes of data in a user-friendly manner are treemaps or treemap reports. Treemaps were developed as a human visualization aid for allowing a viewer to see all the nodes of a large tree structure in a single view. These first treemaps were a mapping of a traditional tree data structure to a two dimensional space, such as a computer monitor screen or a sheet of paper, in which each node was presented as a rectangle with an area or size selected based on some attribute of the tree node, such as size of the underlying data or parameter value. Originally, treemaps were used to view multiple level file directories in a hard disk, and if based on size, a treemap allowed a user to quickly identify which file directories were the largest and using more memory based on the relative size of the rectangles representing the directories.

More work has been completed on treemaps such that the representations of the data can be made clearer such as by creating a squarified treemap (e.g., a treemap in which the data is represented as squares rather than elongate strips or thin rectangles). Nesting and/or bordering has been developed that allows a user to more readily identify related data, e.g., with borders that show nesting or relationships around sets of the rectangles, strips, or squares. More recently, treemaps have been used for displaying a wider variety of data that is related in some manner, e.g., a hierarchical fashion, such as for providing stock portfolio or performance data, for displaying sport statistics, for displaying business information, and for showing many types of enterprise information.

While providing a way to display an incredible amount of information on the limited real estate of a computer monitor screen, existing treemap tools have numerous limitations and problems that need to be addressed to encourage more widespread adoption of this potentially useful data visualization tool. Presently, treemap tools are created and distributed as an inclusive product that is expensive and difficult to alter and update. The treemap tool is typically a proprietary application that is developed for a particular customer and their present needs and installed on their computer system. This has resulted in treemap tools that gather data for generating reports from a single source, such as a standard database, with a series of queries used to fill fields used to generate the treemap. The user of the tool cannot readily change the data source as the tool is set up to query a known data source having a known configuration. Further, the format is fixed such that even if a user is allowed to change data sources the data input to the tool must comply with the formatting and data type requirements of the tool. The user cannot quickly change the queries, i.e., the data used, in creating the report causing the report to be relatively static in nature. If modifications of the tool are allowed at all, the user must involve their information technology personnel or the tool distributor to create new queries and/or to otherwise modify the tool, which may result in a large, unacceptable time delay and add significantly to the cost of using the tool.

When a new report is requested, the tool typically performs a real time retrieval of data from the data source disrupting access to the data source by other users and resulting in a relatively long delay in producing the treemap on the user's monitor screen. To view the report properly, the user typically must utilize a compatible display tool, such as a browser, and is often limited to a specific display tool or browser and even to a specific version of the tool or browser (which can cause problems when the treemap tool or the display tool are later updated or modified). Further, the data that is displayed in the treemap report is often limited in value to the user. The displayed treemap report generally is limited to a single data source and to a single set or level of data within that data source. The display is also static in the sense that the user cannot drill down into a set of data to retrieve additional data or more details from the represented set of data. The existing tools generally are limited to providing a data box when a cursor is placed over a treemap cell or box that may provide some of the information used in creating the treemap but does not provide a way to extract additional information, to link to another process, or to create another treemap. The cells or boxes within the treemap are often not fully proportional to the data used in their creation, e.g., a minimum and/or maximum size may be imposed, that results in cells or boxes being created with similar size even though the underlying data values differ, which can mislead the user when they attempt to make decisions based on the treemap report.

Hence, there remains a need for an improved method and system for assisting users in visualizing large volumes of data on a computer screen or on space-limited display areas. Such a method and system preferably would be extensible or modular to allow portions to be modified or replaced without requiring modification of the entire data visualization tool or system. The method and system would also preferably not be tied to a particular data source, to a data input format, or to a particular display tool or browser. The method and system further would preferably utilize treemap technologies and allow a user to view data in a more dynamic and representative manner, including viewing multiple levels concurrently, drilling down within data sets, showing data in correct proportions, and enabling a user to link to additional reporting and/or analysis tools.

### SUMMARY OF THE INVENTION

The present invention addresses the above problems by providing a method (and corresponding software and hardware components) for use in creating and displaying a user-definable data report, such as a squarized treemap. Generally, the method includes retrieving data from one or more data sources, such as database systems, based on a set of report topics and on a schedule defined by a set of scheduling rules, e.g., to minimize interruption of access to the data sources while providing relatively fresh data. The method continues with periodically, such as weekly, monthly, and the like, generating report data sets by processing the retrieved data to (if necessary) merge data from multiple sources, to aggregate the data to facilitate later mapping, and to create a standardized document, such as a text document and in one embodiment, an eXtensible Markup Language (XML) document. The pre-generated report data sets are published and persisted within a messaging provider or service with data set definitions or meta data for the data sets being stored in a mapping data repository.

The method further includes receiving at a web server a request for a report data set from a mapping client and responding by retrieving, such as from a cache or from the messaging service, the report data set and by transmitting the report data set to the mapping client. In the web server (or on another device) requested report data sets are cached for later distribution to mapping or report clients. The caching preferably is performed based on user parameters tracked by a cache mechanism, e.g., if users repeatedly request data sets from a particular time period these sets are cached. In some embodiments, the method includes applying a data filter (selected based on access rights assigned to the mapping client) to the report data set and transmitting a subset of the report data set. At the mapping client, the method continues with parsing the report data set document, applying a set of mapping algorithms (such as standardized treemap algorithms, squarized treemap algorithms, and the like) to the parsed and previously aggregated data to create a data report (e.g., a treemap), and displaying the data report in a user interface provided on the mapping client. The method further includes receiving via the user interface user selection or modification of report creation parameters, creating a modified or second data report (e.g., a modified treemap), and displaying the modified data report in the user interface.

More particularly, a computer-based method is provided for creating and displaying a user-configurable data report on a user device monitor. The method includes creating a first data report by processing a set of report data that has been configured to a standardized format (e.g., an XML document). A user interface is provided on the monitor and then the first data report is displayed in a report area or window of the user interface. The method includes displaying a hierarchical control tree for the first data report in a control area or window of the user interface. A selection of one of the nodes of the control tree is received via the user interface and the method includes responding by creating a second data report based on the node selection. The second data report is then displayed in the report area of the user interface. In one embodiment of the method, the data report is a treemap or treemap report and the processing of the set of report data includes applying a set of mapping algorithms to the report data based on the control tree hierarchy. The method includes receiving a selection of two or more nodes of the control tree and then the creating and displaying of the second data report includes concurrently displaying sets of cells created to proportionally represent portions of the report data pertaining to the selected nodes.

### BRIEF DESCRIPTION OF THE DRAWINGS

FIG. 1 illustrates in block diagram form a data visualization system configured in a three-tier modular fashion to facilitate extensibility and adapted for utilizing multiple data sources to produce user definable data reports such as treemaps;

FIG. 2 is a flow chart illustrating exemplary functions performed by the data visualization system of FIG. 1;

FIG. 3 illustrates one screen shot of a report definition and display window created by the client mapping tools shown in FIG. 1 and viewable upon the client monitor including an exemplary treemap created by the report design tool portion of the client mapping tool; and

FIG. 4 illustrates another screen shot similar to FIG. 3 illustrating the use of the hierarchy definition area of the report definition and display window for choosing which data is to be aggregated and how that data is to be aggregated in creating the displayed data report, e.g., treemap or treemap report.

### DETAILED DESCRIPTION OF THE PREFERRED EMBODIMENTS

The present invention is directed to methods and systems for enhancing the visualization of large quantities of data in a concise clear manner that includes presenting related data in a visual or graphical manner that is readily understood by a human operator or user. The methods and systems of the invention utilize a modular, tiered approach to presenting the components, such as software applications, that perform the functions necessary to retrieve data from multiple data sources, pre-process the data into a standardized or useful format or form, and to distribute the pre-processed or pre-generated report data sets which may include caching of regularly retrieved sets. A mapping client, e.g., a software application, is installed on a client device or system to create an interactive user interface for displaying data reports and report creation parameters and for facilitating user definition or creation of data reports such as by changing the report creation parameters.

In one embodiment, a backend reporting tool controls retrieval or receipt, aggregation, and storage of data and acts to periodically (or in some cases, on demand) create report data sets. The created report data sets are published to a messaging service for persistent storage and later transmittal to a web server or distribution tool. The created report data sets are preferably extensible Markup Language (XML) documents or some other useful standardized format with data included and aggregated based on predetermined data set topics, e.g., the information to be aggregated in created data reports, information useful for relating and arranging the data, for filtering the data shown in reports, and the like. Data set definitions, e.g., metadata, is stored in an data repository accessible by the backend reporting tool. The XML report data sets are transmitted to a web server running a cache mechanism for storing frequently requested data sets and running a distribution tool for responding to client requests by transferring report data sets based on their request (e.g., the report the client is building). The third tier of the system includes the mapping client devices or systems each running a mapping tool (e.g., a full application loaded on the client) that creates a graphical user interface (GUI) on the client monitor and that creates data reports based on the received report data sets and default reporting creation parameters or parameters set by the user of the client via the GUI. In this manner, the user is not tied to a browser implementation and is able to create additional reports or modified reports in real time (i.e., without creating new queries or modifying the underlying components of the system), is able to drill down into the data, and is able to link to additional reporting or data analysis tools.

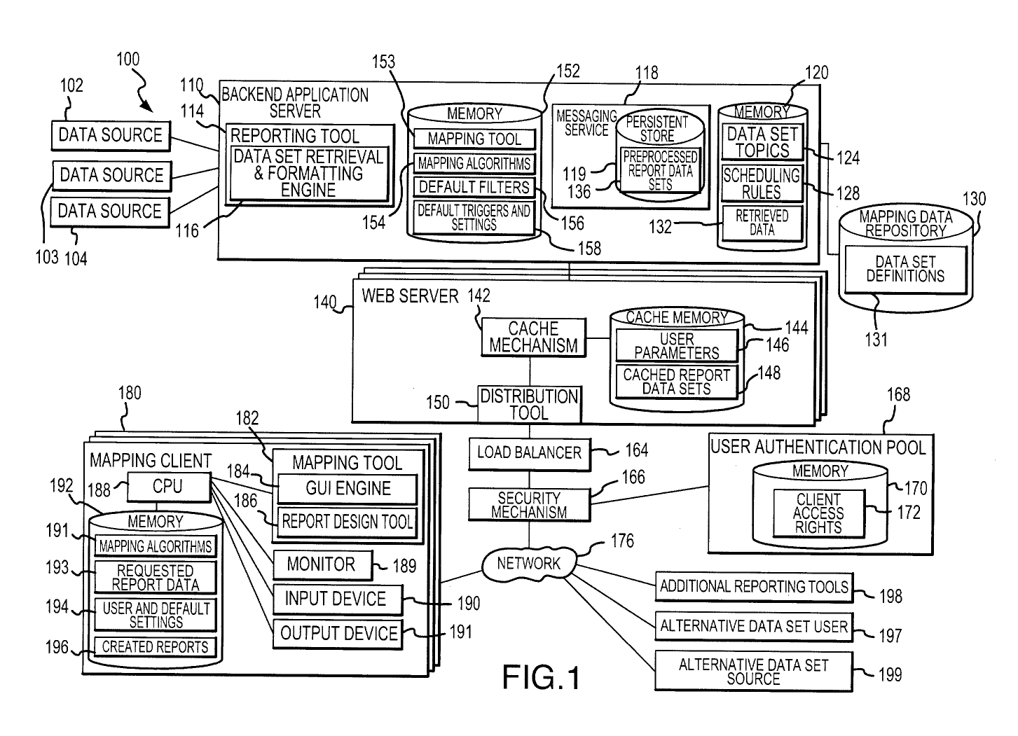

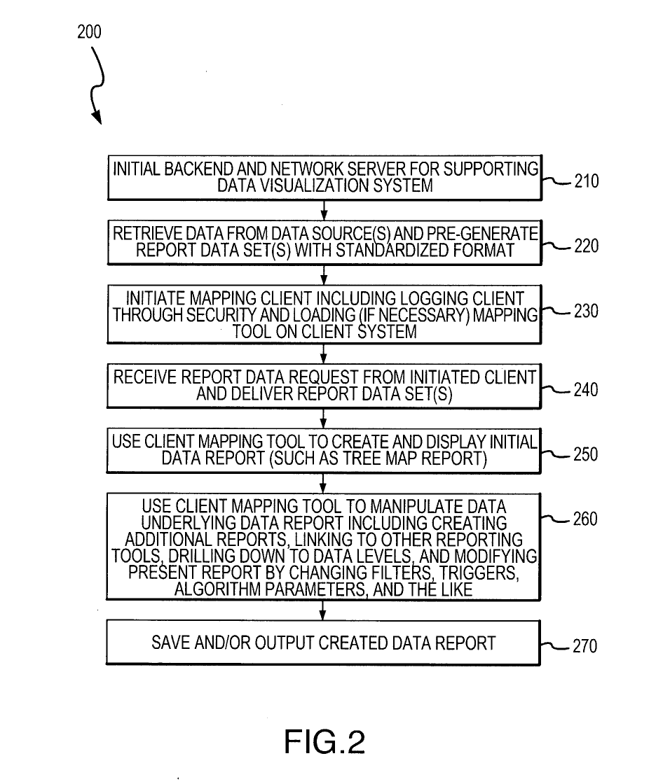

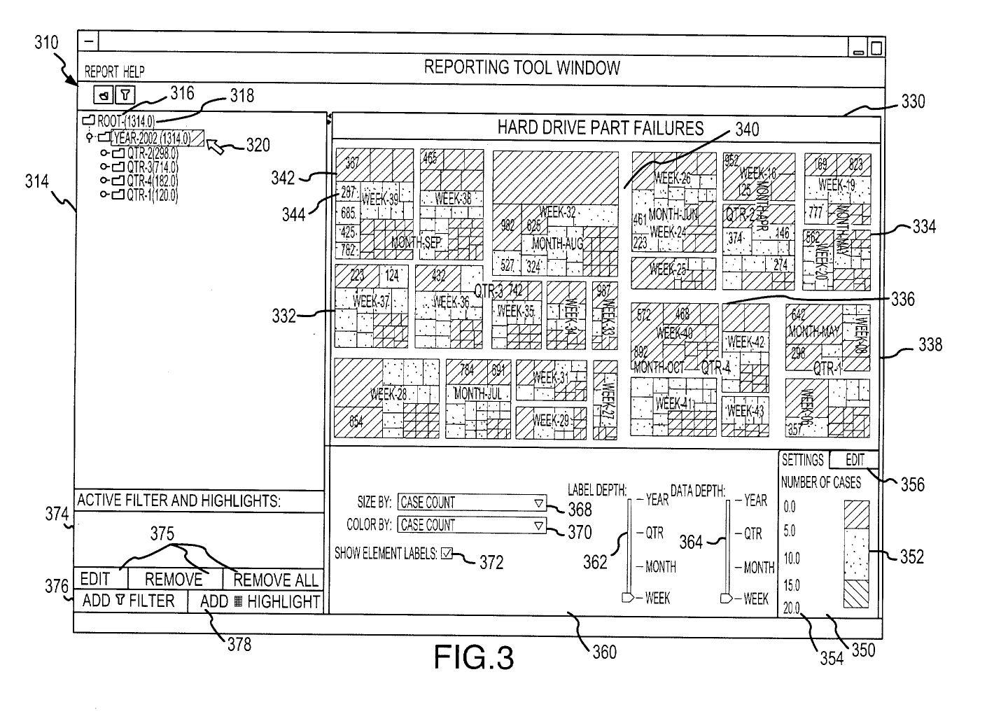

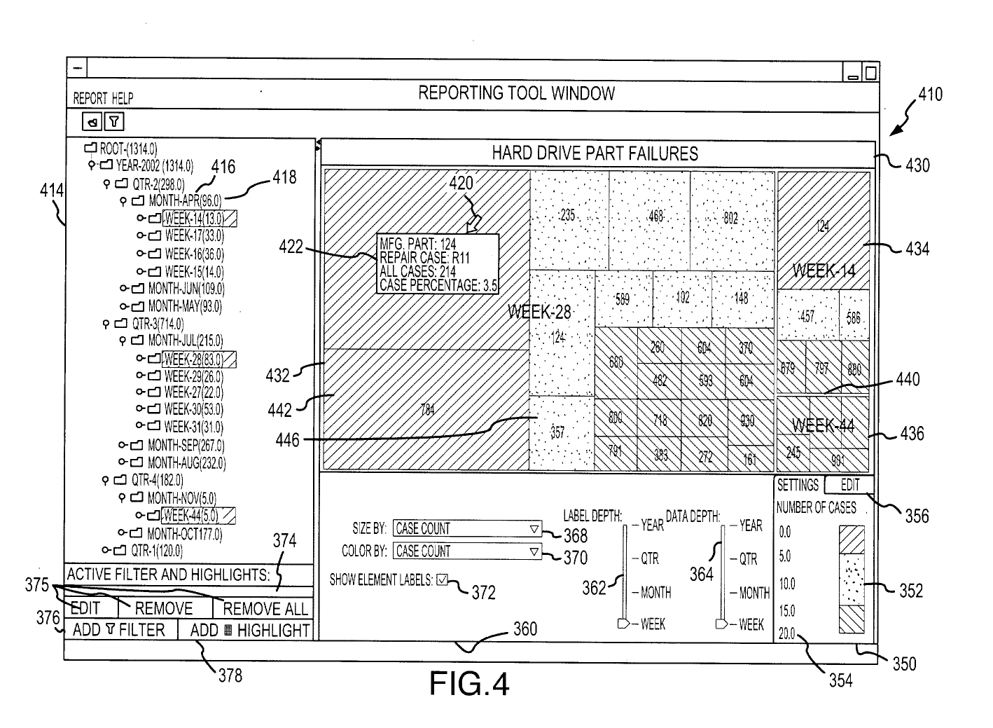

These and other features of the invention will become clear from the following description of an exemplary data visualization system 100, as shown in FIG. 1. The following description begins with a general description of the system 100 with reference to FIG. 1, which is useful for illustrating the independent but cooperative operation of the backend reporting tool 114 and messaging service 118, the cache mechanism 142 and distribution tool 150 on the web server 140, and the mapping tool 182 on the client 180. The functions performed by a data visualization system according to the invention, such as system 100, are explained in more detail with reference to FIG. 2 along with further reference to FIGS. 3 and 4, which illustrate two examples of report definition and display windows that are created by mapping tools of the invention and that are useful for displaying report creation parameters and for allowing a user to alter these parameters to create new, user-defined data reports in real time or upon request.

In the following discussion, computer and network devices, such as the software and hardware devices within the data visualization system 100, are described in relation to their function rather than as being limited to particular electronic devices and computer architectures and programming languages. To practice the invention, the computer and network devices may be any devices useful for providing the described functions, including well-known data processing and communication devices and systems, such as application, database, and web servers, mainframes, personal computers and computing devices (and, in some cases, even mobile computing and electronic devices) with processing, memory, and input/output components, and server devices configured to maintain and then transmit digital data over a communications network. Data, including preprocessed report data sets and requests for data sets and transmissions to and from the elements 102, 103, 104, 110, 130, 140, and 180 and among other components of the system 100 typically is communicated in digital format following standard communication and transfer protocols, such as TCP/IP, HTTP, HTTPS, FTP, and the like, or IP or non-IP wireless communication protocols such as TCP/IP, TL/PDC-P, and the like.

FIG. 1 illustrates a data visualization system 100 according to the present invention adapted for retrieving data from multiple data sources, processing the retrieved data into a more standardized form (such as an XML document), distributing the preprocessed data report sets in cached manner to client devices, and creating at the clients data reports based on the preprocessed data report sets and on user input. As shown, the system 100 includes a plurality of data sources 102, 103, 104 linked (such as by a wired or wireless digital network or communication link) to a backend application server 110. The system 100 is adapted to allow numerous data sources 102, 103, 104 of varying configuration to be mined for data or to supply data based on queries from the reporting tool 114 and more particularly, the data set retrieval and formatting engine 116. This is a departure from prior data visualization systems in which typically only a single data source was allowed or utilized and/or the configuration of that source was predefined, which limited later additions of differently configured data sources. In this regard, the data sources 102, 103, 104 may be any of a number of data sources or repositories typically utilized by enterprise and other systems to store data, such as corporate or entity data warehouses and the like that utilize Oracle or other database management systems or utilize other data structures and may be within the network of the backend application server 110 or be an external source.

The backend application server 110 houses the service components used to create, manage, and publish base and subset report data sets and then transfer the pregenerated report data sets to the web server(s) 140 (or in some systems, to other devices that have subscribed to receive the published data sets such as alternative data set users 197). A reporting tool 114 is provided that includes a data set retrieval and formatting engine 116 for formatting retrieved data into a more standardized form prior to publishing as report data sets and for retrieving data for inclusion in reports from the data sources 102, 103, 104. The retrieved data 132 may be temporarily stored in memory 120 of the server 110 or another memory device linked to the backend application server 110. Once created by the data set formatting engine 116, preprocessed report data sets (i.e., the base sets and subsets of data used in creating data reports by the system 100) 136 are published to a messaging service 118 and stored in persistent store or infrastructure 119 of the messaging service 119 prior to transmittal to other devices, such as the web server 140. The messaging service may be any of a number of messaging services, such as Java Messaging Service (JMS), MQ-Series, and the like. A mapping data repository 130 is linked to the backend application server 110 for storing data set definitions or meta-data that describe or define the preprocessed report data sets 136 such as by identifying data sources 102, 103, 104, defining queries (such as SQL queries) used to retrieve information in the retrieved data 132 from the sources 102, 103, 104, frequency of updates, version control of portions of the data set definitions 131 such as SQL definitions and the like

Also in the memory 120 of the server 130, a predefined set of data set topics 124 is stored for use by the reporting tool 114 in retrieving the data 132 from data sources 102, 103, 104 and in creating the report data sets 136. For example, the data set retrieval and formatting engine 116 is configured for obtaining data from the sources 102, 103, 104 which may be complex, distributed data sources with differing configurations including differing data types, access management systems, and data content. To minimize IT personnel intervention, the data set retrieval and formatting engine 116 is preferably configured to create or at least maintain links to the sources 102, 103, 104 (such as database links), to create and maintain views to the sources 102, 103, 104 (such as database views), and to create and maintain queries or access requests required to retrieve data from the sources 102, 103, 104 (e.g., complex SQL queries in embodiments where the sources 102, 103, 104 comprise conventional databases) that may be stored in repository 130 as part of the data set definitions 131. These queries or access requests may be formulated to retrieve data identified in the data set topics 124, with the data set topics 124 defining information to be aggregated by the data retrieval and formatting engine 116 and to be mapped and presented in created data reports by the mapping tools 182 or for use in creating the reports by the mapping tools 182. The retrieved data 132 may be stored temporarily in server memory 120 for use by the data set retrieval and formatting engine 116 and may be periodically updated based on timelines set by the scheduling rules 128 stored in memory 120 (such as daily, weekly, monthly, quarterly, yearly, and the like). Typically, the scheduling rules 128 for data retrieval or refreshing by the retrieval engine 118 is set to correspond with refreshing of preprocessed report data sets 136 by the formatting engine 116 (such as for the day before a scheduled report update by formatting engine 116).

According to an important feature of the reporting tool 114, the data set retrieval and formatting engine 116 is provided to pre-generate or preprocess the gathered data for publishing to clients and for placing the data of varying type, format, and content into a more standardized form. As discussed above, the retrieved data 132 in many embodiments will include results from queries, such as SQL queries, to one or more of the data sources 102, 103, 104, with the data from multiple sources typically having a common link or a key that is common among the sets of retrieved data to facilitate merging of the data from the different sources 102, 103, 104. The data set retrieval and formatting engine 116 is adapted to use the data set topics 124 to define the content and arrangement of data from the retrieved data within the preprocessed report data sets. The creation of a report data set 136 by the formatting engine 116 in some cases involves the merging of data (i.e., using a common key and the like) from two or more of the data sources 102, 103, 104. For example, one data source 102 may include data on the numbers of a product shipped by a manufacturer while a second data source 103 may be used to track quality and stores the failure count for the shipped products.

The retrieval and formatting engine 116 works (when defined by the data set topics 124 or some other data set configuration file or rules) to combine the data from these two sources 102, 103 into a single preprocessed report data set 136 as these two types of information will likely be aggregated for display on a single data report. The preprocessing includes aggregating the retrieved data 132 (such as based on data set topics 124 or based on a rule in the definitions 131 in repository 130) such that this aggregation does not have to be performed by mapping clients 180 or other users 197, which significantly reduces the processing required to use and display the retrieved data 132. The number of preprocessed report data sets 136 created and published by the data set formatting engine 116 will most likely vary from system 100 to system 100 and may vary over time as data sources 102, 103, 104 are added or deleted and/or as mapping clients 180 are added or deleted requiring or requesting differing content in the report data sets 136.

The data set retrieval and formatting engine 116 preferably updates or refreshes the preprocessed report data sets 136 periodically or based on a schedule defined by the scheduling rules 128 or data set definitions 131 (such as daily, weekly, monthly, and the like) and then publishes the data sets 136 to the messaging service 118 for persisting in store or infrastructure 119 and transfer to web server 140 (to avoid a cache 148 having a stale version of a report data set) or upon a request being made by a mapping client 180 via the web server 140. The scheduling rules 128 can be changed or modified without altering the reporting tool 114 and may vary from data set to data set 136 or from data source to data source 102, 103, 104 to suit the type of data in the data set 136 (e.g., how frequently the data changes) and to control disruption of access to the data sources 102, 103, 104 (e.g., during data gathering by the retrieval and formatting engine 116).

To provide a standardized data set 136, one embodiment of the data set retrieval and formatting engine 116 includes an XML document generator that processes the retrieved data 132 and generates one or more preprocessed report data sets 136 that are XML documents with the data marked up with tags and attributes describing the data (typically, based on the data set topics 124). The pre-generation of XML documents for use as base data sets and subsets 136 allows the ready transfer or publication of the report data sets 136 to the messaging service 119 and later to mapping clients 180 and alternate users 197 which can use an XML parser (such as in the mapping tool 182) to understand the contents of the report sets. The XML parser of the mapping tool can then transfer the data to an application for use such as the GUI engine 184 and/or the report design tool 186 in creation of the data reports (e.g., treemap reports and the like). In some embodiments, a document type definition (DTD) or a schema is provided in the XML document 136 or referenced in the document 136 to facilitate validation or processing by the XML parser in the mapping tool 182.

Because the preprocessed report data sets 136 are in a standardized form, such as an XML document, the reporting tool 114 or messaging service 119 may transmit the data sets 136 to the web server 140 or to numerous other entities (such as the additional reporting tools 198, alternative data set users 197, or a device not shown in system 100), which illustrates the modularity of the backend server application 110 and reporting tool 114 that can be used apart from the system 100. The connections between the reporting tool 114 or messaging service 119 and the alternative data set users 197 may be direct or more direct using a LAN, a WAN, and/or other digital network via protocols such as HTTP, HTTPS, FTP, TCP/IP, and the like as well as using common application protocols such as Java Servlet, HTTP(S) socket, or application services such as Web Services (e.g., SOAP, ebXML, and the like).

In the illustrated embodiment, the reporting tool 114 publishes the preprocessed report data sets to the messaging service 118. The datasets 136 in this embodiment typically are disseminated via a publish-and-subscribe methodology with the dataset messages of the messaging service persisting as long as defined within the scheduling rules 128 and/or definitions 131. In a Java™ programming environment such as a J2EE environment, the messaging service 118 would typically comprise Java Messaging Service (JMS) and the service components of the reporting tool 114 would comprise stateless session, enterprise, and message driven beans that can be asynchronously invoked via JMS messages. The inclusion of the messaging service 118, such as JMS, in the backend application server 110 facilitates base and subset preprocessed report data set caching by the cache mechanism 142 and cache memory 144 of the web server 140. Dissemination of the preprocessed report data sets throughout the cache of the system 100, e.g., to the cache mechanism 142 and memory 144, is supported by the messaging service or provider 118, such as JMS, MQ-Series, and the like. The use of a standard messaging providers or mechanism for service 118 allows for further scalability and availability as well as reduces maintenance requirements that may accompany a custom solution because it leverages industry standard mechanisms that are typically included or provided in messaging providers.

The backend application server 110 further includes memory 152 for storing for the mapping clients 180 mapping algorithms 154 used by the client mapping tools 182 for generating data reports (including default algorithms and, in some cases, user-defined algorithms), default reporting filters 156, and default triggers and other report generation settings 158. Also, the mapping tool 153, e.g., a software application(s), used by the mapping clients 180 is stored on the application server 110 (or in another device accessible by the web server 140) for distribution to and downloading on the mapping clients 180 either initially or upon each connection by the mapping clients 180. The information stored in memory 152 for the mapping clients 180 typically would be provided to the mapping client 180 upon the client 180 accessing the web server 140 or logging in to obtain a secure connection and/or upon request from the mapping tool 182 upon loading as part of initialization on the mapping client 180. Generally, the information stored in memory 152 is then stored locally on the mapping clients 180 as shown in FIG. 1, where default values can be modified to create user-selected filters, highlights, triggers, and other report generation parameters.

The system 100 further includes one or more web servers 140. The web server 140 facilitates the subscription to and transmittal of various report data sets 136 to numerous mapping clients 180. To control distribution of the preprocessed report data sets 136 in a timely and efficient manner, the web server 140 is linked to a load balancer 164 that controls data requests to and communications from the web servers 140. The web server 140 itself includes a cache mechanism 142 linked to cache memory 144 for storing user parameters 146 and selectively storing published or otherwise received preprocessed report data sets 136 as cached report data sets 148. Again, in preferred embodiments, the dissemination of the preprocessed data reports 136 throughout the cache system 142, 144 is facilitated by the messaging service 118. In one embodiment, the user parameters 146 include information on the mapping clients 180 that indicate which of the received report data sets 136 are most frequently requested (such as a data sets from a particular year, from a particular geographical area, and the like) and these reports are stored in memory 144 as cached report data sets 148. In other embodiments, the caching mechanism 142 (or a caching layer in a distributed model) acts to store the most recently received data sets 136 and/or the most recently requested data sets 136 as the cached report data sets 148.

In other cases, discussed below, the caching mechanism 142 works in coordination with the security mechanism 166 such that filtered or subsets of the received report data sets 136 are stored as the cached report data sets 148 and when these identical subsets 148 are requested again by the same or other mapping clients 180 they can be quickly retrieved from the cache memory 144 without further processing or generation by the data set formatting engine 116. The caching within the system 100 can be a distributed cache system, e.g., when the web servers 140 are a cluster of servers, with the synchronization of the cached report data sets 148 being assured by configuring the mailing service of the reporting tool 114 such that when published report data sets 136 are revised or refreshed that these new reports are again published to all web servers 140 and/or cache mechanisms 142 that subscribed to that report data set 136.

A distribution tool 150 (such as a servlet in the Java™ environment) acts within the web server 140 to control mapping client 180 access to the preprocessed report data sets 136 and the cached report data sets 148. The distribution tool 150 generally responds to requests from the mapping clients 180 for one or more data sets 136, 148 by retrieving and delivering the data sets 136, 148 to the mapping client 180 for use in creating data reports with the mapping tools 182. The distribution tool 150 may further be configured to implement a level of security or to provide a level of access control to the retrieved data 132. To this end, the distribution tool 150 may include a filter element that filters select elements from the report data sets 136, 148 prior to transmitting them to the mapping clients 180. In embodiments of the system 100 in which the report data sets 136, 148 are XML documents, an eXtensible Stylesheet Language Transformation (XSLT) processor may be included in the distribution tool to convert the report data sets 136, 148 based on a user parameter such as an access level or user role assigned to the mapping client to a new XML document or other text document using an XSLT stylesheet to determine which elements are to be filtered from the report data sets (e.g., with a different XSLT stylesheet being used for each access level or user role assigned within the system 100). For example, a salesperson may have access to all sales data but not to human resources data. In this manner, runtime security or data access control is provided by the system 100 by transforming base datasets 136, 148 into access-based data subsets that are published to front end reporting or mapping clients 180. This filtered subset may also be published to the cache mechanism 142 for storage in the cache memory 144 as a cached report data subset or set 148 such that subsequent requests by the same or another mapping client 180 with similar access levels result in retrieval of the filtered data set 148 from the local cache 144 within the web server 140 or web server tier of the system 100 rather than from the application server 110 and the messaging service 118.

The web server 140 is linked to the mapping clients 180 via the network 176 (such as the Internet, a LAN, a WAN, or other digital communication network and in some cases using Web Services such as SOAP, ebXML, and the like). A security mechanism 166 (shown as a separate device but could be integrated into the distribution tool 150 or elsewhere in the web server 140) is provided for facilitating a mapping client 180 logging into or registering with the system 100. The security mechanism 166 may utilize standard log in processes and may access a user authentication pool 168 (such as a Lightweight Directory Access Protocol (LDAP) pool or device) with memory 170 to verify that a particular mapping client 180 has requested access rights (or a user role) 172. The access rights determined at log in by the security mechanism 166 is then typically used by the distribution tool 150 in filtering data in the report data sets 136, 148 (at least in some embodiments) to create documents for transmittal to the mapping clients 180.

The system 100 further includes a set of mapping clients 180 that are linked to the web server 140 via network 176. Each mapping client 180 may be a standalone computing device, such as a personal computer, a laptop, a notebook, or other computing device, a workstation in a computer system, and the like. The mapping client 180 includes a processor 188, a monitor 189 for viewing the report data sets 136, 148 in data reports, an input device 190 such as a keyboard, a mouse, and the like for entering and editing report creation parameters (such as those stored in memory 152), an output device 191 (or a port to an output device) to save and/or print static copies of viewed and/or created data reports, and memory 192 for storing mapping algorithms 191 (such as standardized, squarized, and/or other treemap or report generation algorithms), requested report data 193, user and default settings 194 (i.e., the report creation information provided from memory 152 by the web server 140 and, typically, modified by the user via GUI engine 184), and, optionally, created reports 196 formed by the mapping client 180.

The mapping client 180 includes a mapping tool 182, i.e., a software application, for allowing a user of the client 180 to view report data sets 136, 148 for which they have access rights (e.g., by creating and displaying a default data report such as a treemap report) and to create new data reports, drill down into the displayed data, and link to the additional reporting tools 198 that are also linked to the network 176. The functioning of the mapping tool 182 is explained in more detail with reference to FIGS. 2-4. As shown, the mapping tool 182 includes a GUI engine 184 for creating and displaying a user interface on the monitor 189 to display data reports, such a treemaps, formed from the requested report data 193 (which as discussed may be filtered to be a subset of the base report data sets 136, 148). The GUI engine 184 of the mapping tool application 182 eliminates the need for the client 180 to implement a particular browser or browser version.

The GUI engine 184 via the user interface provided on the monitor also typically displays user and default settings 194 used to create the currently displayed data report. In preferred embodiments, the user operates the input device(s) 190 to edit these report creation parameters including mapping algorithms (e.g., in some cases, the user can select from a set of mapping algorithms), filters, highlights, triggers, and display parameters (such as labeling used in the data report and colors utilized such as the cells of a treemap report). The mapping tool 182 further includes a report design tool 186 that creates a data report, such as a treemap, based on the requested data and default mapping algorithms, default filters, and default triggers and other settings (typically transferred with the mapping tool 182 from memory 152). The report design tool 186 further functions with the GUI engine 184 to receive input from the user to alter the current data report such as by selecting a hierarchy node within a displayed hierarchical control (as shown in FIGS. 3 and 4, the aggregation technique can be hierarchically driven and the hierarchy can be changed and nodes selected by the user via the interface provided by the GUI engine 184), the filters, the highlights, the coloring or display triggers (explained in more detail with reference to FIGS. 3 and 4), and other report creation parameters.

The report design tool 186 then acts to create the new data report based on the user entered parameters and using the requested report data (and/or by requesting additional report data sets 136, 148) and to display the newly created data report (such as a treemap) on the monitor 189 via the GUI engine 184. Because the requested data 193 may have a standardized format, the mapping tool 182 will typically include a parser (such as an XML parser) for parsing and understanding the requested report data. The parsed requested report data 193 is then processed according to the mapping algorithms 191 and other report creation parameters currently in effect to create the data report to be displayed on the monitor 189 and/or saved at 196 in memory or output to the device 191 (such as a printer) or to another additional reporting tool 198.

The mapping tool 182 is a modular component that can be used independently from the web server 140 and components of the backend application server 110. For example, the mapping tool 182 can receive data sets or report data 193 from alternative data set source 199, which may be any system or device capable of delivering a document in the standardized format expected by the mapping tool 182 (e.g., an XML or other common format document) and with aggregated data used by the tool 182 in creating the reports.

To better understand the modular nature of the mapping tool 182, it may be useful to understand one specific implementation of the tool 182 in the Java™ programming environment. In this environment, the tool 182 may have a treemap engine at its core. This engine is used to process an XML (or other) data set to create a treemap image including applying a particular treemap algorithm to the aggregated data in the data set and applying user-selected filters, highlights, and other formatting or creation settings. The created report image can then be stored (such as a created report 196). The image can then be retrieved by the mapping tool 182 as a standard image format (e.g., gif jpeg, and the like). The treemap engine of the mapping tool 182 is utilized to display a report such as a treemap image in a GUI component or application or to build a server side component or application that uses the treemap report 196 in a non-visual way. For example, a server side component may be provided in the mapping tool or elsewhere in the client 180 to accept a request, create a treemap image 196, insert the image 196 into a pdf document (or other document), and then mail the pdf document out to a group of users. The next layer in this implementation architecture is a Swing-based component (e.g., GUTI engine) that can be utilized in any Swing GUI application. It retrieves and displays a treemap image generated from the core treemap engine (e.g., tool 186) and typically follows the Swing architecture's Model-View-Controller (MVC) design. The data for the displayed treemap is pulled from a Swing TreeModel data structure can be the same data structure used by standard Swing JTree components, which allows for easy integration with other Swing components. The client application (i.e., the mapping tool 182) integrates the Swing component (GUI engine 184) with other Swing components to provide an interactive data analysis tool. As will be appreciated, the mapping client 180 is shown to request data sets (e.g., XML documents) from the backend application server 110, but the data 193 may come from other sources, e.g., alternative data set source 199, as long as the received data has a structure that can be transformed or parsed by the tool 182 (such as by transforming it into a particular XML schema).

FIG. 2 illustrates an exemplary data visualization or report generation process 200 performed according to the invention and will be explained with reference to FIG. 1 (although the method may be implemented with different system configurations and components). The method 200 begins with the initiation of the backend application server 110 and the network or web server 140 to support providing standardized (and often filtered) report data sets to mapping clients 180. The initiation 210 typically involves loading the reporting tool 114 on the backend application server 110 and the cache mechanism 142 and distribution tool 150 on the web server 140. Communication links are formed and interfaces provided between the data sources 102, 103, 104 and the backend application server 110, between the server 110 and the mapping data repository 130, and between the web server 140 and the backend application server 110.

At 220, the reporting tool 114 with the data set retrieval and formatting engine 116 retrieves sets of data from one or more of the data sources 102, 103, 104 such as based on sets of queries (such as SQL queries and the like) created based on the data set topics 124 (e.g., information to be included in or used in forming data reports at the mapping clients 180) or from definitions 131. The retrieved data 132 is stored (at least in some cases) temporarily in memory 120 for later processing. The retrieval performed at 220 may be performed initially and then again periodically based on schedules (that can be configured or altered by operators of the server 110) for refreshing or updating the retrieved data 132 and/or preprocessed report data sets 136. Also at 220, the data set retrieval and formatting engine 116 acts to pre-generate a set of base report data sets 136 for use in creating data reports by the mapping clients 180. Generally, this includes aggregating data based on a number of topics 124 or elements such as geographic region, country, regions, states, cities, departments, revenue, operating expenses, sales, number of particular products sold or produced, and many other aggregation parameters. The retrieval and formatting engine 116 typically includes a document or object generator for transforming the potentially diverse formats of the retrieved data 132 into a standardized document or object (such as a text document, including an XML document) that is then published to the messaging service 118 to be persisted as data sets 136 in store 119 of the service 118.

At 230, a mapping client 180 is initiated by logging onto the system 100 by obtaining a secure connection via the network 176 and security mechanism 166. When log in is successful and the mapping client 180 has a verified/assigned access right 172, the mapping client 180 (at least initially) acts to download a latest version of the mapping tool 153 to the mapping client 180 from the backend server 110 via the web server 140. The downloading of the mapping tool 182 may not be repeated for each log in but may be limited to initial log in or upon a modification to the mapping tool 153. During downloading, the mapping algorithms 154 and default filters 156 and triggers and settings 158 are typically transferred to the mapping client 180 (or in some embodiments, these sets of report generation information are stored at the mapping client 180).

At 240, a user of the mapping client 180 enters a report data request by operating the input device 190 and interacting with a user interface displayed on the monitor 189 by the GUI engine 184 (such as by selecting with a mouse or keyboard a report tab or button). The request is received at the distribution tool 150 of the web server 140. The distribution tool 150 contacts the cache mechanism 150 to determine whether the requested report data is in a cached report data set 148 or whether the report data is needs to be requested from the backend application server 110, i.e., is in a preprocessed report data set 136. The distribution tool 150 further applies, if applicable, a security check to determine whether the requesting mapping client 180 has access rights that allow full viewing of the information in the report data set 136, 148. The access rights may be applied on an element by element basis, to a full data set, or to portions of the data set to create a subset of the report data set 136, 148. The requested data is then transferred to the requesting mapping client 180 (or a subset of the requested data based on the application of the security filter) and stored by the mapping client 180 at 193 in memory 192.

According to an important feature of the invention, the steps 250 and 260 involve the user or operator of the mapping client 180 interacting with the requested report data 193 using point-and-click technology to display default data reports, to create and display user-defined data reports, to drill down within the data including obtaining additional report data sets 136, 148, and linking to additional reporting tools 198. To this end, the mapping client 180 includes the mapping tool 182 with a GUI engine 184 and a report design tool 186 for freeing the mapping client 180 from a particular browser and for in real time creating a user interface for use in displaying data reports and allowing the user to design new data reports. In the following discussion, the data reports are described as treemaps or treemap reports, and more particularly squarified treemaps with borders showing nested or hierarchical relationships of aggregated data (i.e., the requested data 193). It will be clear to those skilled in the art, however, that many of the features of the invention, such as loading the mapping tool 182 on the client 180 with its on-client functionality and providing backend preprocessing of data sets and caching of data reports, are readily applicable to other data report types and configurations.

At 250, the mapping tool 182 uses the GUI engine 184 to display a report design and display interface on the monitor 189. In FIG. 3, an exemplary interface 310 is shown, and the user would typically operate their mouse or input device 190 to select a “Report” button to initiate the report design tool 186 to request the data from the distribution tool 150. The report design tool 186 creates the initial or default treemap report based on the requested report data 193 and default algorithms and report creation settings or parameters (or saved user settings) 194 and the GUT engine 184 operates to create the interface 310 with the treemap shown in data report window 330 (e.g., with the label of “Hard Drive Part Failures”). The report design tool 186 (e.g., a runtime tool) is configured to create the requested report data 193 based on a set of mapping algorithms 191, such as well-known standard, squarized, or other treemap algorithms. Although not shown, in some embodiments, the user of the mapping tool 182 can alter the mapping algorithms or portions of the algorithms, select from a set of available algorithms 191, and save these new mapping algorithms as a user setting 194 for use in creation of future treemaps.

In a preferred embodiment, the report design tool 186 further is driven by a user-controllable hierarchy. In this regard, the interface 310 includes a hierarchy tree window 314 in which the current hierarchy tree of the report data 193 shown in the treemap in report window 330 is illustrated. The control tree in the window 314 includes a root 316 with a time hierarchical structure with a year node and quarterly branch nodes. The cursor 320 is shown as selecting the year node, which is acted upon by the report design tool 186 in creating a treemap shown in window 330 that includes all data in the year aggregated by the four quarter nodes shown. As shown, the treemap includes four quarterly cells 332, 334, 336, 338 that are separated by borders 340 to indicate the hierarchical or nesting relationship between the data. All data has been selected in the interface, and the treemap in window 330 includes the months of each quarter that are further divided into the weeks of the month with part numbers being tracked shown in the colored and labeled boxes.

The depth of the data and labeling shown within the quarterly cells 332, 334, 336, 338 is selectable by the user via the interface 310 with the label and data depth slide bars 362, 364 shown in report parameters or report creation setting window 360. The data depth parameter represented by slide bar 364 is used by the report design tool 186 in determining how many levels of the requested report data 193 are viewed concurrently within a single treemap in window 330. Prior treemap generators lacked the ability to show multiple levels of data simultaneously and further, provided no method for a user to simply select a data or hierarchical level for comparison in a treemap. In contrast, the report design tool 186 is adapted to respond to a change in the data depth parameter as defined by the location of the data depth slide bar 364 (although many other input devices can be used for this parameter) to determine which levels of the data hierarchy are to be displayed for each node shown in the control tree of window 314 and to automatically create a new treemap in response to changes of this data depth parameter. For example, the user of the interface 310 may decide to move the data depth slide 364 from “week” to “month” and the report design tool 186 would respond by creating a new treemap for display in window 330 that no longer aggregates “size by” values by week but instead aggregates the “size by” values by month. Note, the ability of a user to see multiple levels within a treemap hierarchy simultaneously is a powerful functionality that allows the user to define treemap reports at runtime without needing to build new reports (i.e., typically does not require the request of new report data sets 136, 148 and does not require the creation of treemap algorithms and/or the performance of additional data gathering processes).

The aggregation parameter or “size by” value used by the report design tool 186 for sizing the cells of the treemap in window 330 is shown in parentheses behind the root 318 and nodes to enable a user to quickly determine the relative importance or size of each node, e.g., to assist a user in determining which nodes or aggregated data may merit further investigation such as by drilling down into the node. The size of the quarterly cells 332, 334, 336, 338 show the relative size of that quarter based on the quantity of “size by” parameters occurring in that quarter. As can be seen, the largest cells within a nest are presented in the left portion of the cell and generally in the upper portion of the cell. For example, the third quarter cell 332 shown in the treemap represents a total of 714 “size by” items which is larger in quantity than the other quarters and the third quarter cell 332 is shown in the left portion of the treemap. Similarly, in the month of September, there were more parts represented by cell 342 than parts represented by cell 344 fabricated or shipped and hence, the report design tool 186 positioned cell 342 above cell 344.

According to an important feature of the invention, the user of the mapping tool 182 is able to define a number of the report creation settings and/or parameters. In this regard, the method 200 continues at 260 with the mapping tool 182, via the report design tool 186 and GUI engine 184, facilitating the user in manipulating the report data 193 (and report data sets 136, 148) by creating additional data reports, drilling down into the data and into different data levels, and linking to different reporting tools 198. The creation of new data reports, e.g., new treemaps created by the report design tool at runtime and then displayed in window 330, can be achieved through the mapping tool 182 in a number of ways. As discussed above, the hierarchical control tree is displayed in window 314 that is being used by the report design tool 186 in creating the treemap shown in window 330. The user via the interface 310 can open the nodes, such as the nodes shown with folders, to view the data below that node in the hierarchical control tree. The user can then select (e.g., via the interface provided by the GUI engine 184) two or more values on similar levels of the hierarchy in the newly displayed control tree for creation of a new treemap. The report design tool 186 responds by automatically creating a new treemap and displaying the treemap in window 330. In this manner, the user is able to quickly create a new treemap simply by altering the displayed control tree in window 314, such as to compare different levels of the hierarchy (e.g., to compare same months of different years, months of different quarters, weeks of different quarters or years, and the like).

Referring to FIG. 4, the concept of creating new treemaps at runtime by altering the hierarchy control tree is explained more fully by showing a user interface 410 that is displayed when the user has opened the quarter nodes of the tree in FIG. 3 and then some of the newly displayed month nodes of the control tree in window 414. The user can move the cursor 420 with input device 190 to open the nodes of the tree in window 414, such as month node 416, to display additional nodes, such as weeks of the month. Again, the “size by” value 418 for each node is displayed in parentheses. The user can select which portions of the control tree shown in window 414 that are to be included in the created and displayed treemap by pointing and clicking (or otherwise indicating a selection with an input device, such as voice selections) the cursor 420. The selected nodes (as long as they are of a similar level of the control hierarchy such as weeks of a month) are then included within a treemap report generated by the report design tool 186 and then displayed in window 430. As shown, three weeks (i.e., the first week of three quarters) are displayed in treemap cells 432, 434, and 436 with the week cells being separated by borders 440. The “size by” values of the week are used to size the week cells 432, 434, and 436 as well as the part number cells, such as cells 442, 446 within the week cells 432, 434, 436.

Note, that the “size by” values are totaled and displayed for each level of the hierarchy tree shown in windows 314, 414 to allow a user to quickly determine values without having to add counts of the “size by” parameters. In some embodiments, the report design tool 186 also is configured to display all cells within each window in proper relative proportion, e.g., the report design tool 186 does not utilize maximum and minimum sizes for cells that would result in many cases in disproportionate representation of the data within the treemap as some cells or boxes would be too small relative to the underlying data and some cells or boxes would be presented too large relative to the underlying data.

At 260 of process 200, there are other ways in which the report design tool 186 supports runtime definition and creation of new treemaps. As shown in FIG. 3, additional report creation parameters or settings are displayed in windows 360, 374 and many of these settings may be selected by the user and this results in the automatic response by the report design tool 186 in the creation and display of a new treemap in window 330. In window 374, the active filters and active highlight parameters are displayed and can be edited or modified.

Generally, filters are used by the report design tool 186 to narrow what data is included in the report or treemap displayed in window 334. For example, if no filters are set, all data is shown (such as all part numbers in a sales or production implementation). The buttons 375 can be selected to edit and remove filters and/or highlights. When button 376 is selected, the GUI engine 184 displays a dialog box or other data entry device to allow a user to enter or add filters that are then automatically applied by the tool 186 in creating a next treemap or report for display n window 334. For example, the user may be able to select which data field (i.e., aggregated parameter or data element) is to be filtered and then to select one or more displayed filter values (such as part numbers and the like). In a preferred embodiment, the selected filter is used by the tool 186 to “filter” all non-matching fields or, in other words, to include only data fields matching the selected filter. For example, if a part number were selected as a filter, each cell would be sized based on the aggregation of the data field corresponding to that part number with all other part numbers not being used in creating the treemap or report shown in window 334.

Highlights are used to allow the user to indicate to the report design tool 186 which cells should be highlighted, such as by coloring of select cells and not coloring the other cells. In one embodiment, this is achieved by selecting a data element or field for comparing to a trigger value (see, also item 354 for trigger values used in coloring settings). For example, when button 378 is selected to add a highlight, the GUI engine 184 may operate to display a dialog box allowing the user to select a data field to highlight, to select a comparison operand (e.g., “=”, “<”, “>”, and the like), and a highlight trigger or value. Once a highlight is entered, the report design tool 186 acts to create a new report or treemap that is displayed in the window 334 using the highlight values entered by the user and applied to the aggregated data 193.

In the setting window 360, the sizing parameter or “size by” parameter or setting is shown at 368 as the “case count” or number or cases of products. The pull down menu at 368 can be selected to display other options for use in creating the treemap in window 334 with the report data 193 and algorithm 191, and each of these available “size by” settings can be selected by the user. The “color by” setting or parameter is shown at pull-down menu 370 and is currently set at “case count” but can also be set by the user via the interface 310. The user can also elect to show element or cell labels or to not show these labels by selecting box 372.

The user can also manipulate the data and create reports by interacting with trigger values and colors of cells based on such triggers. As shown in FIG. 3, a legend window 350 is provided that displays in color bar 352 the colors used for coloring the cells in treemap in window 330 (as shown three colors, such as green, yellow, and red, are shown by solid crosshatch lines, dots, and dashed crosshatch lines but of course more colors may be shown including shades between main colors). Also shown at 354 are triggers or trigger levels used by the report design tool 186 in determining what color to use for each cell within the treemap shown in window 330. The triggers shown in the example of FIG. 3 are quality control parameters of failures per case or percentage of failures of manufactured or shipped products. For example, a green color may be used for less than 6 percent failures (or a shade of green), a yellow color for failure counts between 6 and 15 percent (or shades of yellow), and a red color for failure counts over 15 percent (or shades of red). The use of color or some other visual indicator in the cells of the treemap provide a quick visual indicator for a user of the treemap as to information that is important to the user (such as quality problems). An edit button 356 may be selected by the user to allow them to edit the trigger levels, the information used for triggering color or visual indicator changes (such as by switching from failures to some other triggering criteria), the number of triggers and therefore, number of colors used, and the specific color or visual indicators used or used for various levels.

As shown in FIG. 4, the user can place the cursor 420 over a particular cell within the treemap shown in window 430 and a mouse over or pop up box 422 is displayed by the GUI engine 184. Preferably, the box 422 provides summary data for the underlying report data for that selected cell. Additionally, in some embodiments, the user is able to place the cursor 420 over a cell and select (such as by right clicking a mouse) the option of linking to other tools. This can be thought of as the creation of dynamic hyperlinks by the tool 186, and typically, one or more hyperlinks will be provided in a pop up box to allow a user to link to additional reporting tools 198 and/or to link to additional sources of information pertaining to the underlying data in the selected cell. When a link is selected, the tool 186 may provide all or at least a portion of the data underlying the particular cell (in which the hyperlink option is selected) to the tool 198 or device addressed in the link.

Referring again to FIG. 2, the method 200 continues with at 270 with the user saving the treemap or other created data report and/or outputting the created treemap or data report. At 270, the user via the interfaces 310, 410 of FIGS. 3 and 4 can select to save the treemap or report created in local memory 196 (or in memory 152) for later use and processing. The saved report can then be viewed later as it appears on the interface 310, 410. The created data report can also be output as it appears on the screen or window 330 to a local output device 191 (or to another device external to the mapping client 180). For example, the report design tool 186 upon request from a user may generate a pdf or other format file of the created data report for printing, for saving, and for transferring or publishing to other devices (such as via e-mail message attachments).

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. For example, the report design tool 186 may be configured to provide a number of additional report modification functions including allowing a user to create text labels on the cells of a treemap, to create custom calculated columns, to configure border color, width, and/or shading, to set menu options in the interfaces of FIGS. 3 and 4, to set the height and width of the report window (and displayed report or treemap) at run time, and to define custom attributes names for a particular data object.

We claim:

1. A computer-based method for creating and displaying a user-configurable data report on a user device having a monitor, comprising:
creating a first data report including processing a set of report data configured in a standardized format;
providing a user interface on the monitor;
displaying the first data report in a report area of the user interface;
displaying a hierarchical control tree for the first data report in a control area of the user interface;
receiving through the user interface a selection of a node in the control tree;
creating a second data report including processing the set of report data based on the node selection; and
displaying the second data report in the report area of the user interface.

2. The method of claim 1, wherein the processing of the set of report data to create the first data report includes parsing an extensible Markup Language (XML) document.

3. The method of claim 1, wherein the processing of the set of report data to create the first data report includes applying a set of mapping algorithms to the set of report data based on the control tree, wherein the first data report comprises a treemap report.

4. The method of claim 3, wherein the treemap report includes a plurality of cells each representing a portion of the set of report data and wherein the cells are sized to provide a proportional representation of the portion of the report data.

5. The method of claim 4, further including receiving a selection of another node in the control tree, wherein the second data report displaying includes concurrently displaying the cells for the portions of the report data related to the two selected nodes.

6. The method of claim 4, wherein at least some of the cells are colored to indicate a relationship between the portion of the set data represented by the cells and a trigger value, further including displaying in a legend area of the user interface a coloring legend showing a set of colors used in the coloring of the cells relative to the trigger value.

7. The method of claim 6, further including receiving an editing input for the trigger value or the set of colors, and in response, creating a third data report including processing the set of report data based on the editing input and displaying the third data report in the report area of the user interface.

8. The method of claim 3, further including displaying a set of report creation parameters used during the creating steps in a parameters area of the user interface, receiving via the user interface a user selection of a replacement parameter for one of the report creation parameters, creating a third data report including processing the set of report data based on the replacement parameter, and displaying the third data report in the report area of the user interface.

9. The method of claim 8, wherein the report creation parameters are selected from the group consisting of mapping filters, size-by parameters, and color-by parameters.

10. The method of claim 8, wherein the report creation parameters include data depth parameters, the data depth parameters defining a hierarchical level in the set of report data for use in the aggregation by the mapping algorithms.

11. The method of claim 1, further including displaying a link to a reporting tool on the user interface, receiving a selection of the link through the user interface, and linking to the reporting tool including providing a portion of the report data to the reporting tool.

12. The method of claim 1, further including receiving via the user interface a print request and in response, printing a copy of the first data report or the second data report displayed in the report area of the user interface.

13. A data visualization system for use in creating and displaying a data report on a monitor of a mapping client, comprising:
a memory device storing data set topics and scheduling rules; and
a reporting tool including a data set retrieval engine retrieving a set of data from a data source defined in part by the data set topics and on a timing schedule defined by the scheduling rules and further including a data set formatting engine generating report data sets from the retrieved set of data including aggregating portions of the retrieved data set and publishing the generated report data sets, wherein the generated report data sets are formatted as a text document.

14. The system of claim 13, wherein the data source comprises a database system and the text document is an XML document.

15. The system of claim 13, further including a cache mechanism receiving the report data sets published by the data set formatting engine and caching at least a portion of the received report data sets.

16. The system of claim 15, wherein the portion of the received report data sets is defined by user parameters stored by the cache mechanism based on requests for the received report data sets by the mapping client.

17. The system of claim 15, wherein the cache mechanism is provided on a web server, and further including a distribution tool on the web server responding to a request from the mapping client for one of the received report data sets and in response, transmitting the requested report data set to the mapping client.

18. The system of claim 17, wherein the distribution tool applies a security filter based on an access right assigned to the mapping client to the requested report data set prior to the transmitting, whereby a subset of the requested report data set is transmitted to the mapping client.

19. The system of claim 13, further including a mapping tool running on the mapping client, the mapping tool adapted to perform functions including: creating a data report including parsing one of the generated report data sets and applying a set of mapping algorithms to the parsed one of the data sets to form a treemap; providing a user interface on the monitor; and displaying the data report in a report area of the user interface.

20. A method in a computer system for displaying a graphic representation of data based on user input on a monitor of a client device, comprising:
displaying a user interface on the monitor including a report window and a report parameters window;
in the report window, displaying a treemap comprising a plurality of blocks representing a portion of information in a data set, the blocks being sized based on a value of a sizing parameter in the portion of information;
in the report parameters window, displaying a set of parameters used in creating the displayed treemap;
receiving a modification of one of the displayed parameters; and
based on the modified one of the displayed parameters, displaying a modified version of the treemap in the report window.

21. The method of claim 20, wherein the displayed parameters include a data depth parameter defining a level in a hierarchy of the data set for inclusion of the portion of the information for representation in the blocks of the treemap.

22. The method of claim 20, wherein the blocks are colored a color selected based on the relationship of a trigger value in the portion of the information with a trigger level and wherein the displayed parameters include the trigger level and the modified one is the trigger level.

23. The method of claim 20, wherein the displayed parameters are selected from the group consisting of a size-by parameter, a color-by parameters, a data filter, a coloring trigger, and a data depth parameter.
